(19) United States
(12) Patent Application Publication
(10) Pub. No.: US 2020/0308066 A1
(43) Pub. Date: Oct. 1, 2020

(54) Ceramic Matrix Composite Articles and Methods for Manufacturing the Same

(71) Applicant: General Electric Company, Schenectady, NY (US)

(72) Inventors: Joseph John Shiang, Niskayuna, NY (US); Ryan Christopher Mills, Rexford, NY (US); Jared Hogg Weaver, Clifton Park, NY (US)

(21) Appl. No.: 16/367,884

(22) Filed: Mar. 28, 2019

(51) Int. Cl. C04B 35/80; C04B 41/45; C04B 41/50; C04B 35/638; C04B 35/634

(52) U.S. Cl. CPC C04B 35/806; C04B 41/457; C04B 41/50; C04B 35/638; C04B 38/0067; C04B 2235/5244; C04B 2235/5268; C04B 2235/616; C04B 35/634

(57) ABSTRACT

CMC articles and methods for forming CMC articles are provided. In one example aspect, a method for forming a CMC article includes forming a CMC preform defining a first section and a second section. The first section has one or more plies that include sacrificial fibers. The second section of the CMC preform does not include sacrificial fibers. The first and second sections can be laid up to form the CMC prior to thermally processing, e.g., consolidation, firing, and infiltration. When the CMC preform is fired or burned out, the sacrificial fibers are removed or decomposed resulting in formation of channels within the first section of the pyrolyzed CMC preform. The channels are used as gas transport paths during chemical vapor infiltration to facilitate infiltration of a gaseous infiltrant into the fired CMC preform. The channels are then backfilled with a liquid infiltrant during a melt infiltration process.

### FIELD

The subject matter of the present disclosure relates generally to ceramic matrix composites (CMC) and methods for making the same.

### BACKGROUND

Ceramic matrix composites (CMCs) generally include a ceramic fiber reinforcement material embedded in a ceramic matrix material. The reinforcement material serves as the load-bearing constituent of the CMC, while the ceramic matrix protects the reinforcement material, maintains the orientation of its fibers, and serves to dissipate loads to the reinforcement material. Of particular interest to high-temperature applications, such as in gas turbine engines or hypersonic applications, are silicon-based composites, which include silicon carbide (SiC) as the matrix and the reinforcement material. CMCs, particularly continuous fiber ceramic composite (CFCC) materials, are currently being utilized for shrouds, combustor liners, nozzles, and other high-temperature components of gas turbine engines.

Different infiltration methods have been employed in forming CMCs. For example, one approach includes chemical vapor infiltration (CVI). CVI is a process whereby a matrix material is infiltrated into a fibrous preform by the use of reactive gases at elevated temperature to form the fiber-reinforced composite. CVI composite matrices typically have no free silicon phase, and thus have good creep resistance and the potential to operate at temperatures above 1400° C., or about the melting point of silicon depending on the impurities therein. One drawback to CVI is the excess residual porosity that occurs when the pores become closed off. The closed off pores prevent the reactive vapor infiltrant from penetrating into the interior of the preform. This reduces matrix dominated properties such as the interlaminar tensile strength.

Another infiltration approach includes melt infiltration (MI), which employs molten metal to infiltrate into a fiber-containing preform. While the MI process leaves no or minimal residual porosity, some of the molten metal remains unreacted within the preform. Accordingly, the matrix of MI composites typically contains an amount of a free metal phase (e.g., elemental silicon or silicon alloy for silicon melt infiltration) that limits use of the CMC to below that of the melting point of the silicon or silicon alloy, or about 1400° C. Moreover, the free metal phase causes the MI SiC matrix to have relatively poor creep resistance.

To realize the advantages and minimize the drawbacks of the CVI and MI infiltration processes, attempts at forming hybrid CMC articles that include CVI and MI infiltrated substrates have been made. However, forming such hybrid articles has proven to be difficult, namely due to the conflicting processing requirements of CVI and MI. For instance, in one approach, an MI substrate is laid up and is processed through MI. Then, additional plies are laid up onto the MI substrate and the article is then processed through CVI. The drawback of this approach is that the process temperature of the article is limited by the free silicon of the MI substrate, leading to an article with inferior mechanical properties. In another approach, a CVI substrate is laid up and is processed through CVI. Then, additional plies are laid up onto the CVI substrate and the article is then processed through MI. The drawback to this approach is that the MI substrate (or additional plies added to the CVI substrate) can be difficult to access due to the geometry of the article.

Accordingly, improved CMC articles and methods for forming CMC articles that address one or more of the challenges noted above would be useful.

### BRIEF DESCRIPTION

Aspects and advantages of the invention will be set forth in part in the following description, or may be obvious from the description, or may be learned through practice of the invention.

In one aspect, the present disclosure is directed to a method for forming a CMC article. The method includes forming a CMC preform defining a first section and a second section, the first section comprising a slurry, reinforcing fibers, and sacrificial fibers and the second section comprising a slurry and reinforcing fibers. Further, the method includes removing the sacrificial fibers to define channels in the first section of the CMC preform. In addition, the method includes subjecting the CMC preform to chemical vapor infiltration to densify the CMC preform with an infiltrant. Further, the method includes subjecting the densified CMC preform to melt infiltration to backfill the channels with a liquid infiltrant.

In another aspect, the present disclosure is directed to a CMC article defining a first section and a second section. The CMC article includes a ceramic matrix and a plurality of ceramic reinforcing fibers disposed throughout the ceramic matrix. Further, the CMC article includes one or more infiltrant veins traversing the first section of the CMC article, wherein the second section has a thickness greater than about 0.75 mm.

In another aspect, the present disclosure is directed to a method for forming a CMC article. The method includes laying up a preform having a first section and a second section, the first section having a plurality of plies comprising a slurry and reinforcing fibers and the second section having a plurality of plies comprising a slurry and reinforcing fibers, and wherein one or more of the plurality of plies of the first section comprise sacrificial fibers. Further, the method includes consolidating the preform at elevated temperatures and pressures to form a pre-green state article. The method also includes firing the pre-green state article to form a green state article, wherein during firing, the sacrificial fibers are burned out such that a plurality of elongated channels are defined by the first section of the green state article. In addition, the method includes subjecting the green state article to chemical vapor infiltration to densify the green state article with an infiltrant to form a CVI-densified article. The method further includes subjecting the CVI-densified article to melt infiltration to backfill the plurality of elongated channels with an infiltrant.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a flow diagram of a method for forming a CMC article according to an embodiment of the present disclosure;

FIG. 2 provides a schematic view of an example first ply according to an embodiment of the present disclosure;

FIG. 3 provides a schematic view of an example second ply according to an embodiment of the present disclosure;

FIG. 4 provides a schematic, side view of an example CMC preform according to an embodiment of the present disclosure;

FIG. 5 provides a schematic, cross-sectional view of the CMC preform of FIG. 4;

FIG. 6 provides a schematic, cross-sectional view of a portion of a first section of the CMC preform of FIG. 4 after a consolidation process;

FIG. 7 provides a schematic, cross-sectional view of the CMC preform of FIG. 4 after a firing process;

FIG. 8 provides a schematic view of a portion of the first section of the fired CMC preform of FIG. 7;

FIG. 9 provides a schematic, cross-sectional view of a portion of the first section of the CMC preform of FIG. 4 undergoing a CVI process;

FIG. 10 provides a schematic view of the CVI-infiltrated CMC preform of FIG. 9 undergoing a melt infiltration process;

FIG. 11 provides a schematic, cross-sectional view of a portion of the first section of the melt-infiltrated CMC preform according to an embodiment of the present disclosure;

FIG. 12 provides a schematic, cross-sectional view of an CMC article formed in accordance with the method of FIG. 1; and

FIG. 13 provides a schematic view of a portion of a gas turbine engine for use with an aircraft according to an embodiment of the present disclosure.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. For instance, features illustrated or described as part of one embodiment can be used with another embodiment to yield a still further embodiment.

As used herein, the terms “first,” “second,” and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows and “downstream” refers to the direction to which the fluid flows. As used herein, the “average particle diameter” or “average fiber diameter” refers to the diameter of a particle or fiber such that about 50% of the particles or fibers have a diameter that is greater than that diameter, and about 50% of the particles or fibers have a diameter that is less than that diameter. As used herein, “substantially” refers to at least about 90% or more of the described group. For instance, as used herein, “substantially all” indicates that at least about 90% or more of the respective group has the applicable trait and “substantially no” or “substantially none” indicates that at least about 90% or more of the respective group does not have the applicable trait. As used herein, the “majority” refers to at least about 50% or more of the described group. For instance, as used herein, “the majority of” indicates that at least about 50% or more of the respective group have the applicable trait.

In the present disclosure, when a layer is being described as “on” or “over” another layer or substrate, it is to be understood that the layers can either be directly contacting each other or have another layer or feature between the layers, unless expressly stated to the contrary. Thus, these terms are simply describing the relative position of the layers to each other and do not necessarily mean “on top of” since the relative position above or below depends upon the orientation of the device to the viewer. Furthermore, chemical elements are discussed in the present disclosure using their common chemical abbreviation, such as commonly found on a periodic table of elements. For example, hydrogen is represented by its common chemical abbreviation H; helium is represented by its common chemical abbreviation He; and so forth.

A method for manufacturing a CMC article is provided. The method includes forming a CMC preform defining a first section and a second section. The first section and the second section are formed of a plurality of plies derived from one or more prepreg tapes. The first section and the second section may be laid up in a stacked arrangement, e.g., before thermally processing the CMC preform. For instance, the second section can be stacked on the first section to form the CMC preform. One or more plies of the first section comprise a slurry, reinforcement fibers, and sacrificial fibers. The plies containing the sacrificial fibers can be interspersed with plies comprising a slurry and reinforcement fibers. The second section is formed of plies comprising a slurry and reinforcement fibers. Notably, none of the plies of the second section comprise sacrificial fibers. The sacrificial fibers can be introduced in the tape making and/or layup process of the manufacturing process and can be generally cylindrical bodies or have other shapes.

The sacrificial fibers can be disposed as single strands, woven or nonwoven mats, continuous grids (e.g., continuous in two dimensions and a single layer), or various other configurations as well as combinations thereof. The sacrificial fibers are generally resistant to solvents present in the tape making process and have enough thermal integrity to resist flow during the autoclave process. The sacrificial fibers also generally do not decompose at temperatures present in the autoclave process; however, the sacrificial fibers do decompose during the burnout process. The composition of the sacrificial fibers may be chosen to target a specific char yield to provide the desired structure of the elongate channels. For example, in some embodiments, it may be desired to have some degree of scaffolding in the elongate channels, thus, a polymer with a higher char yield may be used to form the sacrificial fibers. In other embodiments, it may be desired to have uniform elongate channels, thus, a polymer with a lower char yield may be used to form the sacrificial fibers. In yet other embodiments, the sacrificial fibers can be composed of metal and mechanically removed from the preform.

Once the CMC preform is formed, the CMC preform can undergo thermal processing. For instance, the CMC preform can be consolidated, e.g., at elevated temperatures and pressures in an autoclave, fired or burned out to pyrolyze the matrix precursor of the slurry, and infiltrated to densify the porous fired CMC preform. In some implementations, the sacrificial fibers can be removed mechanically, thermally (e.g., melting, vaporizing, and/or decomposing), and/or chemically (e.g., dissolving into a solvent and/or chemical etching). In some implementations, for example, firing the CMC preform decomposes or otherwise removes the sacrificial fibers, resulting in formation of channels. In certain embodiments, the sacrificial fibers are resistant to any solvent present in the tape making process and are able to survive autoclave conditions (for example, temperatures of about 200° C. or less, such as about 50° C. to about 200° C.). In some embodiments, the sacrificial fibers decompose or pyrolyze to form porous elongated channels within the CMC preform, such as under decomposition conditions at temperatures such as about 200° C. to about 650° C.

Notably, the formed channels are arranged in a gradient along the thickness of the part. That is, as only one or more plies of the second section included sacrificial fibers, channels are formed only within the first section of the CMC preform and not within the second section. Further, the diameter, position, volume fraction, and length of the sacrificial fibers disclosed herein can provide the desired size, shape, and distribution of the channels within the first section of the CMC preform. One or more sacrificial fibers can be used. The channels can be elongated channels. As used herein, “elongate” or “elongated” refers to a body with an aspect ratio (length/width) of greater than 1.

Densification of the green state or fired CMC preform is performed via chemical vapor infiltration (CVI) and then via melt infiltration (MI). During CVI, a gaseous infiltrant infiltrates into the porous CMC preform to densify the CMC preform. The channels formed from the sacrificial fibers increase permeability, in a controlled manner, to improve infiltration into the CMC preform. Particularly, the channels facilitate infiltration into the porous, green state preform by providing gas transport paths for the gaseous infiltrant. The size or diameter of the channels prevent them from being plugged or closed off, thus allowing for infiltration into the interior portions of the CMC preform. This may, for example, reduce the residual porosity of the final CMC article. The use of the sacrificial fibers to form channels can be particularly beneficial for preforms requiring long infiltration distances to ensure complete infiltration. Further, the channels formed from the sacrificial fibers may also provide a pathway for gas to escape during CVI. Gas may evolve from preforms at infiltration temperatures, and if the gas does not have a way to escape, pressure can build in the preform. This may result in bubbles or other voids/pockets in the resulting CMC. The channels formed from the sacrificial fibers of the present disclosure may prevent the increase in pressure by providing a path for gas to escape the preform. In some implementations, the channels can be treated with a polymer solution prior to MI, e.g., to provide better wetting for improved capillary action of the infiltrant into the CMC preform.

After CVI or after treating the CVI-infiltrated CMC preform with a polymer solution, the CVI-densified CMC preform is subjected to MI to backfill the partially infiltrated channels. During the CVI process, the channels may only be partially filled and residual porosity may still be present in and along the channels. Accordingly, the CVI-densified CMC preform is melt infiltrated to backfill the elongated channels with an infiltrant (e.g., a liquid molten silicon) to further densify the article and minimize the residual porosity of the final CMC article. Due to the nature of the MI process, some of the liquid molten infiltrant may remain unreacted, and thus, infiltrant veins comprising unreacted infiltrant may be formed. For instance, in the case of silicon as the infiltrant, infiltrant veins comprising unreacted silicon may be present in the first section of the final CMC article. The second section of the CMC article does not include infiltrant veins because, as noted above, the second section does not include channels formed by sacrificial fibers.

The final CMC article having improved density and mechanical/thermal properties may thus be formed. The final CMC article can be thermally processed without need to layup additional tapes or plies. Notably, the final CMC article has a second section that is thermally capable of being exposed to environments having high temperatures, e.g. temperatures above the melting temperature of the unreacted infiltrant within the infiltrant veins of the first section. In short, the second section creates a thermal gradient between the high temperature environment and the first section of the CMC article that may, as noted above, contain unreacted infiltrant. Preferably, the second section of the CMC article has a thickness that creates a thermal gradient such that the first section of the CMC article is not exposed to temperatures above the melting temperature of unreacted infiltrant.

The CMC article can be utilized in a wide variety of applications and industries. For instance, the CMC article can be utilized in high pressure compressors (HPC), fans, boosters, high pressure turbines (HPT), and low pressure turbines (LPT) of both airborne and land-based gas turbine engines. For instance, the CMC article can be used for a turbofan engine or turbomachinery in general, including turbojet, turboprop and turboshaft gas turbine engines, including industrial and marine gas turbine engines and auxiliary power units. For example, the CMC article can be components such as combustion liners, shrouds, nozzles, blades, etc. The CMC article could also be used in other applications, such as a structural component in a hypersonic vehicle. A hypersonic vehicle can be a vehicle that travels at least 4 times faster than the speed of sound, or greater than Mach 4. Example hypersonic vehicles include, without limitation, airplanes, missiles, and spacecraft.

CMC materials of particular interest to the invention are silicon-containing, carbon containing, or oxide containing matrix and reinforcing materials. Some examples of CMCs for use herein can include, but are not limited to, materials having a matrix and reinforcing fibers comprising non-oxide based materials such as silicon carbide, silicon nitride, silicon oxycarbides, silicon oxynitrides, silicides, carbon, and mixtures thereof. Examples include, but are not limited to, CMCs with a silicon carbide matrix and silicon carbide fiber; silicon nitride matrix and silicon carbide fiber; silicon carbide matrix and carbon fiber; and silicon carbide/silicon nitride matrix mixture and silicon carbide fiber. Furthermore, CMCs can have a matrix and reinforcing fibers comprised of oxide ceramics. Specifically, the oxide-oxide CMCs may be comprised of a matrix and reinforcing fibers comprising oxide-based materials such as aluminum oxide (Al₂O₃), silicon dioxide (SiO₂), yttrium aluminum garnet (YAG), aluminosilicates, and mixtures thereof. Aluminosilicates can include crystalline materials such as mullite (3Al₂O₃ 2SiO₂), as well as glassy aluminosilicates. Other ceramic composite materials that are not comprised of either silicon or oxygen may be used, including zirconium carbide, hafnium carbide, boron carbide, or other ceramic materials, alone or in combination with the materials noted above.

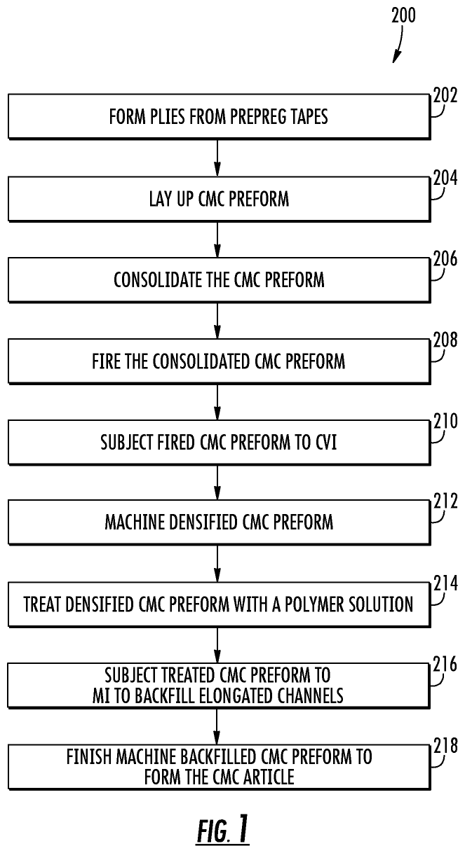

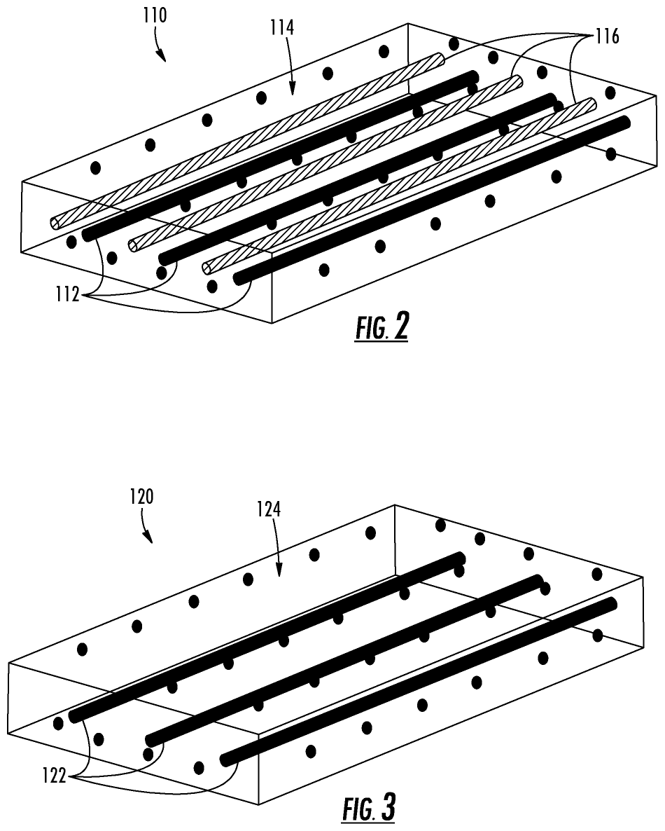

FIG. 1 provides a flow diagram of a method (200) for forming a CMC article according to an embodiment of the present disclosure. Reference will be made to FIGS. 2 through 12 to provide context to method (200). For instance, method (200) can be used to form a CMC article formed from the materials described above.

At (202), the method (200) includes forming plies. The plies can be derived from one or more prepreg tapes. In some implementations, the plies can be derived from a first prepreg tape and a second prepreg tape. More particularly, a plurality of first plies can be derived from a first prepreg tape and a plurality of second plies can be derived from a second prepreg tape. Accordingly, the method (200) can include forming a plurality of first plies derived from a first prepreg tape and forming a plurality of second plies derived from a second prepreg tape.

FIG. 2 provides a schematic view of an example first ply 110 according to an embodiment of the present disclosure. As will be explained in detail herein, one or more first plies 110 may be laid up to form a CMC preform. As shown in FIG. 2, the first ply 110 includes reinforcement fibers 112, sacrificial fibers 116, and a slurry 114. The reinforcement fibers 112 and the sacrificial fibers 116 are shown embedded within the slurry 114. The first ply 110 illustrated in FIG. 2 is a unidirectional ply (e.g., the reinforcing fibers 112 are generally disposed in a parallel direction relative to each other). When substantially all of the reinforcing fibers 112 within a single ply are disposed in a parallel direction relative to each other, the ply may be referred to as “unidirectional.” Although not shown, in some embodiments at least one reinforcing fiber 112 in each layer is disposed in a perpendicular direction relative to another reinforcing fiber 112 within the respective layer. When substantially all of the reinforcing fibers 112 within a single ply are disposed in a parallel direction or a perpendicular direction such that the fibers are woven, the ply may be referred to as “cross-woven.” Multiple first plies 110 or layers may be laid up in various directions (e.g., first, second, third, fourth, and fifth directions, etc.). For instance, one ply may have reinforcing fibers oriented in a first direction and another ply may have reinforcing fibers oriented in a second direction. The first direction may be positioned in any orientation with respect to the second direction, such as about 0° to about 90°, such as about 45°. While FIG. 2 depicts an embodiment with a unidirectional ply, the present method and materials can be used with a single unidirectional, cross-woven, or nonwoven ply, or multiple unidirectional, cross-woven, and/or nonwoven plies with plies layered in a variety of orientations, or in a multidirectional weave or braid. As used herein, “nonwoven” generally refers to the unordered disposition of fibers such as in a web with fibers disposed in a variety of orientations and configuration. Various configurations can be used without deviating from the intent of the present disclosure.

The reinforcing fibers 112 may be any suitable fibers that provide reinforcement for the resulting CMC article and may comprise any of the CMC materials set forth herein. The reinforcing fibers 112 may be more specifically referred to as ceramic reinforcing fibers 112. While in the embodiment illustrated in FIG. 2 the reinforcing fibers 112 may generally be comprised of the same material, the reinforcing fibers 112 of the first ply 110 may vary in composition and/or the reinforcing fibers 112 may vary in composition across multiple first plies 110.

In some embodiments, the reinforcing fibers 112 may have at least one coating thereon. For instance, in particular embodiments, the at least one coating can have a layer selected from the group consisting of a nitride layer (e.g., a silicon nitride layer), a carbide layer (e.g., a silicon carbide layer), a boron layer (e.g., a boron nitride layer), a carbon layer, and combinations thereof. For example, the at least one coating can be deposited as a coating system selected from the group consisting of a nitride coating and a silicon carbide coating; a boron nitride, a carbide, and a silicon nitride coating system; a boron nitride, a silicon carbide, a carbide, and a silicon nitride coating system; a boron nitride, a carbon, a silicon nitride and a carbon coating system; and a carbon, a boron nitride, a carbon, a silicon nitride, and a carbon coating system; and mixtures thereof. If present, the coating thickness can be about 0.1 micrometer (μm) to about 4.0 μm. In some embodiments, the reinforcing fibers 112 may coated with a silicon-doped boron nitride coating (B(Si)N).

The reinforcing fibers 112 are generally continuous in a single ply. That is, each reinforcing fiber 112 is generally a continuous strand across the ply as opposed to fragments of fibrous material. The reinforcing fibers 112 may have any suitable diameter or length to provide the desired ceramic product. In some embodiments, the reinforcing fibers 112 may have a diameter of about 5 μm to about 20 μm, such as about 7 μm to about 14 μm. In some embodiments, the reinforcing fibers 112 may be considered monofilaments and have an average diameter of about 125 μm to about 175 μm, such as about 140 μm to about 160 μm.

The slurry 114 can include various components such as a resin, a suitable curing agent, a binder, carbonaceous solids, particulates (e.g., silicon, polymers), a suitable solvent, a combination of the foregoing, and/or other suitable constituents. For instance, the slurry 114 may include various matrix precursor materials of the CMC materials set forth herein. Suitable ceramic precursors or powders for the slurry composition will depend on the composition desired for the ceramic matrix of the CMC article. For SiC—SiC articles, for example, suitable precursors or powders include carbon, and/or one or more other carbon-containing particulate materials. A suitable binder for use in the slurry composition is polyvinyl butyral (PVB), a commercial example of which is available from Eastman Chemicals under the name BUTVAR® B-79. Other potential candidates for the binder include other polymeric materials such as polycarbonate, polyvinyl acetate and polyvinyl alcohol. The selection of a suitable binder will depend in part on its compatibility with the rest of the slurry components. One example solvent can include isopropanol (C₃H₈O). In some embodiments, it may be beneficial to include surfactants, dispersing agents, and/or other components in the slurry, as well as matrix precursor material for the ceramic matrix.

In some embodiments, the sacrificial fibers 116 can include any suitable fibers that are stable in the slurry 114, can withstand compression and heating, and decompose during the decomposition/pyrolysis stage (e.g., at (208) of method (200)). In some embodiments, the sacrificial fibers 116 have a decomposition temperature or melting point at or lower than the temperature at which decomposition/pyrolysis is performed. For instance, the sacrificial fibers 116 may have a decomposition temperature of about 200° C. to about 700° C., such as about 200° C. to about 600° C., or about 400° C. to about 600° C. Suitable materials for the sacrificial fibers 116 may include polymers such as semi-crystalline polymers, cross-linked polymers, amorphous polymers, or combinations thereof, such as crosslinked phenolic resin, crosslinked poly (vinyl butyral), polyamides, polyesters, and combinations thereof. In certain embodiments, low melting point metals or reactive metals that can be etched via liquid or gases may be used as the sacrificial fibers 116 alone or in combination with any of the aforementioned sacrificial materials. While in the embodiment illustrated in FIG. 2 the sacrificial fibers 116 may generally be comprised of the same material, the sacrificial fibers 116 of a single ply may vary in composition and/or the sacrificial fibers 116 may vary in composition across multiple plies. The sacrificial fibers 116 are generally continuous in a single ply. That is, each sacrificial fiber 116 is generally a continuous strand across the ply as opposed to fragments of fibrous material. In other embodiments, it may be desired to form sacrificial fibers 116 of both continuous strands and fragments, while in other embodiments it may be desired to form sacrificial fibers 116 of fragments only.

Generally, the sacrificial fibers 116 act as place holders until the firing or burnout process. As will be explained in detail herein, when the CMC preform is fired or burned out, the sacrificial fibers 116 are burned out or otherwise removed. As a result, a plurality of channels are defined or formed. Advantageously, the channels facilitate infiltration of an infiltrant into the article during CVI. Experimental and microstructural modeling studies have indicated the importance of channels, such as channels about 10 μm to about 300 μm in diameter, in supplying infiltrants, such as silicon, to the reaction front in composite parts, particularly thick composite parts. If there are too many channels or the channels are too large, the resulting infiltrant veins may reduce the mechanical and thermal properties of the part. To maximize the probability of infiltration success, while minimizing any mechanical/thermal property reduction, the size and distribution of the channels can be controlled as described herein.

For example, in some embodiments, a single sacrificial fiber may be used to deliver infiltrant to a particularly difficult to infiltrate area, while in other embodiments, such as larger parts with significant infiltrant delivery issues, more sacrificial fibers may be used. The sacrificial fibers 116 can also have any suitable diameter such as about 5 μm to about 600 μm, such as about 10 μm to about 500 μm, and may have any suitable aspect ratio (length/width), such as about 10 to about 10,000, or about 20 to about 5,000. In yet other embodiments, the sacrificial fibers 116 can have a diameter about 10 μm to about 200 μm. In certain embodiments, the sacrificial fibers 116 have an aspect ratio such that each sacrificial fiber traverses the substantial length or width of a CMC preform as continuous fibers.

As further shown in FIG. 2, for this embodiment, the sacrificial fibers 116 are disposed in a substantially parallel direction in relation to each other. The sacrificial fibers 116 may be disposed in various directions with respect to each other and may be disposed without a particular orientation, similar to a nonwoven. The sacrificial fibers 116 may be woven to form a woven mat or grid while forming a CMC preform and/or may be woven prior to incorporation into the CMC preform. When used in a multidirectional weave or braid, the sacrificial fibers may be oriented both in-plane and out-of-plane.

The first ply 110 or plies may be prepared in a variety of ways. In some embodiments, the reinforcing fibers 112 and the sacrificial fibers 116 may be introduced into the slurry 114 along with other additional desired components. Once the slurry 114 is combined with the reinforcing fibers 112 and the sacrificial fibers 116, they may be wound on a drum roll to form a tape and then cut into plies. In other embodiments, the slurry can be introduced to the fibers via tape casting, screen printing, or any other suitable method. The slurry 114 and method of introducing the slurry 114 to the reinforcing fibers 112 and the sacrificial fibers 116 may be modified depending on the orientation of the reinforcing fibers 112 and the sacrificial fibers 116.

FIG. 3 provides a cross-sectional view of an example second ply 120 according to an embodiment of the present disclosure. As will be explained in detail herein, one or more second plies 120 may be laid up to form a CMC preform. As shown in FIG. 3, the second ply 120 includes reinforcement fibers 122 and a slurry 124. The reinforcement fibers 122 are shown embedded within the slurry 124. Notably, the second ply 120 or plies may be formed in the same or similar manner as the first plies 110 (FIG. 2) and with the same or similar materials except that the second plies 120 do not include sacrificial fibers. Once the first and second plies 110, 120 of FIGS. 2 and 3 are formed or derived from their respective prepreg tapes, the plies may be laid up to form a CMC preform as described below.

At (204), returning to FIG. 2, the method (200) includes laying up a CMC preform. For instance, one or more first plies 110 (FIG. 2) and one or more second plies 120 (FIG. 3) can be laid up to form a CMC preform. In some implementations, a CMC preform can be laid up to define or having a first section and a second section. The first section of the CMC preform can be laid up with a combination of first plies 110 (FIG. 2) and second plies 120 (FIG. 3). The second section of the CMC preform can be laid up with a plurality of second plies 120 (FIG. 3). One or more plies of the CMC preform can be layered having various relative orientations. For instance, one or more plies may be cross-plied or layered directly over each other such that the fibers are oriented in the same direction. The configuration of the fibers in the plies may be modified depending on the desired CMC product and desired mechanical properties of the CMC product. The reinforcing fibers 112 and the sacrificial fibers 116 within the composite may be unidirectional, cross-woven, and/or nonwoven. An example is provided below.

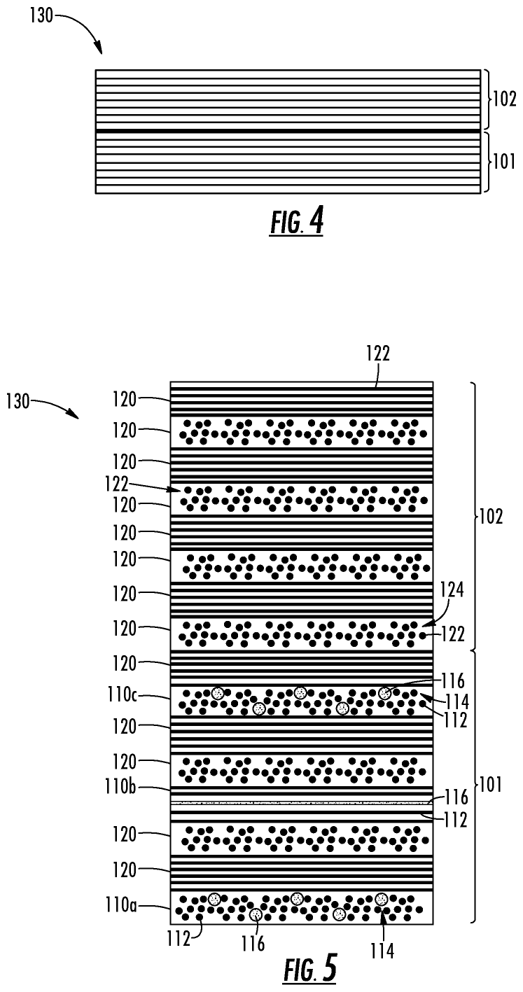

With reference now to FIGS. 4 and 5, FIG. 4 provides a side view of an example CMC preform 130 according to an embodiment of the present disclosure and FIG. 5 provides a schematic, cross-sectional view of the CMC preform 130 of FIG. 4. As shown, the CMC preform 130 is laid up having or defining a first section 101 and a second section 102. The second section 102 is stacked on top of the first section 101 for this embodiment.

As shown, the first section 101 has a plurality of first plies (denoted as 110a, 110b, and 110c) and a plurality of second plies 120. The first section 101 can be laid up with any suitable number of plies. The first section 101 includes three (3) first plies 110 interspersed with the second plies 120. Stated differently, the first section 101 of the CMC preform 130 is laid up such that the second plies 120 comprising the sacrificial fibers 116 are spaced from one another by one or more second plies 120 that do not comprise the sacrificial fibers. Particularly, for this embodiment, the plies of the first section 101 are laid up such that every third ply is a first ply 110 and the two (2) plies between the first plies 110 are second plies 120. In this way, particularly for the 0-90° lay up arrangement of the first section 101, the sacrificial fibers 116 extend longitudinally in alternating directions. For instance, in this example, the sacrificial fibers 116 of the bottom first ply 110a extend longitudinally into and out of the page, the sacrificial fibers 116 of the middle first ply 110b extend longitudinally from the left to the right of the page, and the sacrificial fibers 116 of the top first ply 110c extend longitudinally into and out of the page. In alternative embodiments, the entire first section 101 of the CMC preform 130 may be formed of first plies 110. In yet other embodiments, the first section 101 of the CMC preform 130 may be formed by alternating first and second plies 110, 120. In some embodiments, two (2) first plies 110 can be laid up consecutively and spaced from one another by a number of first plies 110. This pattern may repeat for the thickness of the first section 101 of the CMC preform 130. In further embodiments, the first plies 110 can be interspersed with the second plies 120 in another suitable fashion. Interspersing second plies 120 with the first plies 110 can minimize the number of channels to backfill via MI.

The second section 102 of the CMC preform 130 has a plurality of second plies 120. Notably, the second section 102 does not include any first plies 110, or plies that include sacrificial fibers. Accordingly, when the sacrificial fibers 116 of the first plies 110 are removed (e.g., burned out during firing of the CMC preform), the resulting channels are arranged in a gradient along a first direction (e.g., the thickness) of the CMC preform 130. That is, a plurality of elongated channels are defined along the first section 101 of the CMC preform 130 and no elongated channels are defined along the second section 102 of the CMC preform 130.

For this embodiment, the second section 102 includes eight (8) second plies 120 each having a thickness of about 0.2 to 0.3 mm. In some embodiments, the second section 102 preferably has between about three (3) and ten (10) plies. In yet other embodiments, the second section 102 preferably has between one (1) and sixteen (16) plies. Further, in some embodiments, the thickness of the second section 102 is between about 0.75 mm and 3 mm. In yet other embodiments, the thickness of the second section 102 is between about 0.2 mm and 6 mm. In some embodiments, the second section 102 of the CMC preform 130 interfaces with a relatively hot environment (e.g., a hot gas path of a turbine engine) and the first section 101 of the CMC preform is spaced from the relatively hot environment (e.g., by the thickness of the second section 102).

In some embodiments, the first section 101 and the second section 102 can be laid up at the same time and then combined together. For example, the second section 102 can be laid up on the first section 101. In yet other embodiments, the first and second sections 101, 102 can be laid up successively with one layer or ply being laid one on top of the other, e.g., on a layup table or mold. Notably, the CMC preform 130 can be laid up as single laminate prior to any thermal processing, e.g., consolidation, firing or burnout, and infiltration, which provides advantages and benefits over conventional practices.

At (206), returning to FIG. 2, the method (200) includes consolidating the CMC preform to form a pre-green state article. For instance, in some implementations, consolidating the CMC preform includes vacuum bagging the CMC preform and subjecting the bagged CMC preform to elevated temperatures and pressures to debulk/compact the CMC preform. For instance, the consolidation stage may be performed at a temperature of about 200° C. or less. An example portion of the first section 101 after consolidation is provided below.

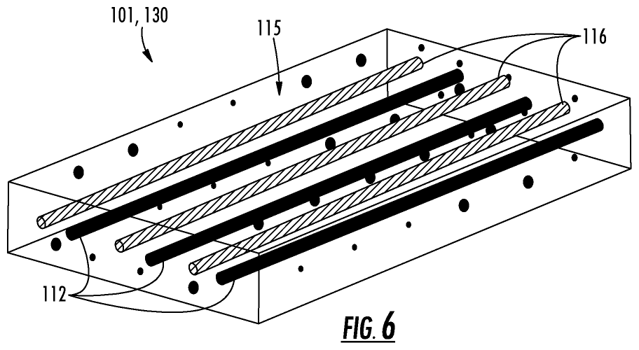

FIG. 6 provides a cross-sectional view of a portion of the first section 101 of the consolidated CMC preform 130 (FIGS. 4 and 5) according to an embodiment of the present disclosure. As shown, the first section 101 of the consolidated CMC preform 130 includes reinforcing fibers 112, sacrificial fibers 116, and matrix precursor material 115. Consolidating the CMC preform 130 at (206) removes some or all of the solvent of the slurry 114 of the first plies 110 (FIG. 2) leaving the matrix precursor material 115. Further, although not shown, consolidating the CMC preform 130 at (206) removes some or all of the solvent of the slurry 124 of the second plies 120 (FIG. 3) leaving the matrix precursor material. As further shown in FIG. 6, the sacrificial fibers 116 are prepared such that the sacrificial fibers 116 are stable during the consolidation stage. The sacrificial fibers 116 can be included in various amounts relative to the first section 101 of the CMC preform 130. For instance, the sacrificial fibers 116 can be included in an amount of about 0.1% by volume to about 20% by volume, such as about 1% by volume to about 15% by volume, about 1% by volume to about 10% by volume, or about 1% by volume to about 7% by volume of the first section 101 of the CMC preform 130. After consolidation, the bag (not shown) is removed from the CMC preform 130 and the resultant CMC preform is in a pre-green state.

At (208), the method (200) includes firing the consolidated CMC preform (i.e., the pre-green state CMC preform). Firing the consolidated CMC preform burns out the binder from the slurry, and notably, burns out, decomposes, or otherwise removes some or all of the sacrificial fibers to define elongated channels in the first section of the fired CMC preform. An example of the defined elongated channels within the first section of the fired CMC preform is provided below.

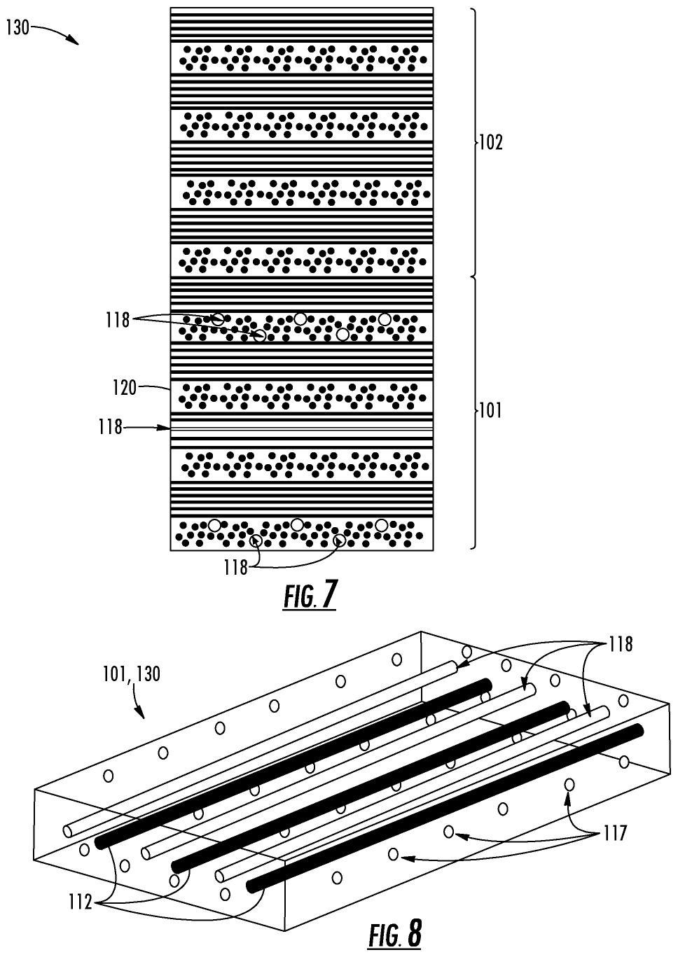

Referring now to FIGS. 7 and 8, FIG. 7 provides a cross-sectional view of the CMC preform 130 after firing at (208) and FIG. 8 provides a schematic view of a portion of the first section 101 of the fired CMC preform 130 according to an embodiment of the present disclosure. As shown, decomposition of some or all of the sacrificial fibers 116 (FIG. 2) results in the formation of elongated channels 118 in the first section 101 of the fired CMC preform 130. Some or all of the matrix precursor material 115 (FIG. 6) can also be decomposed forming pores 117 in the fired CMC preform 130 (represented schematically in FIG. 8). Pores may be formed throughout the fired CMC preform 130. The distribution of the pores 117 may vary and may be controlled to provide the desired porosity in the CMC preform 130. Firing or decomposition may occur at temperatures of about 200° C. to about 700° C., such as about 200° C. to about 650° C., or about 400° C. to about 600° C. The decomposition atmosphere may be oxidizing, reducing, inert, or vacuum. The reinforcing fibers 112, 122 are maintained in the final CMC article 100 (FIG. 12).

The elongated channels 118 are generally continuous hollow channels formed in the fired CMC preform 130. Depending on the degree of decomposition or removal of the sacrificial fibers 116, the elongated channels 118 may have various amounts of scaffolding throughout the channels. For instance, with higher char yield polymers, the elongated channels 118 may have more scaffolding while with lower char yield polymers, the elongated channels 118 may have less scaffolding. The elongated channels 118 are sufficiently porous to allow the flow of infiltrant to fill the elongated channels 118, and may generally be considered cylindrical hollow channels with a higher length than diameter/width. When substantially all of the sacrificial fibers 116 decompose, the elongated channels 118 may have substantially the same size and distributions (for example, the same volume % and aspect ratio) as that of the sacrificial fibers 116. After firing the consolidated CMC preform at (208) to remove the sacrificial fibers 116, among other elements, the fired CMC preform is densified as described below.

At (210), the method (200) includes subjecting the fired preform (i.e., a green state article) to chemical vapor infiltration (CVI). Generally, in a chemical vapor infiltration (CVI) process, an infiltrant in the form of reactive gases infiltrates the porous, green state CMC preform and reacts to form a ceramic material, such as silicon carbide. That is, the method may include reacting the infiltrant with the ceramic precursor (e.g., carbon in some form) to form the ceramic matrix (e.g., silicon carbide). The infiltrant, such as e.g., methyltrichlorosilane, fills the pores and elongated channels to form a densified part. Notably, the elongated channels facilitate infiltration into the porous, green state preform by providing gas transport paths for the gaseous infiltrant. The size or diameters of the elongated channels prevent them from being plugged or closed off thus allowing for infiltration into the interior portions of the article. This may, for example, reduce the residual porosity of the final CMC article. An example densified CMC preform is provided below.

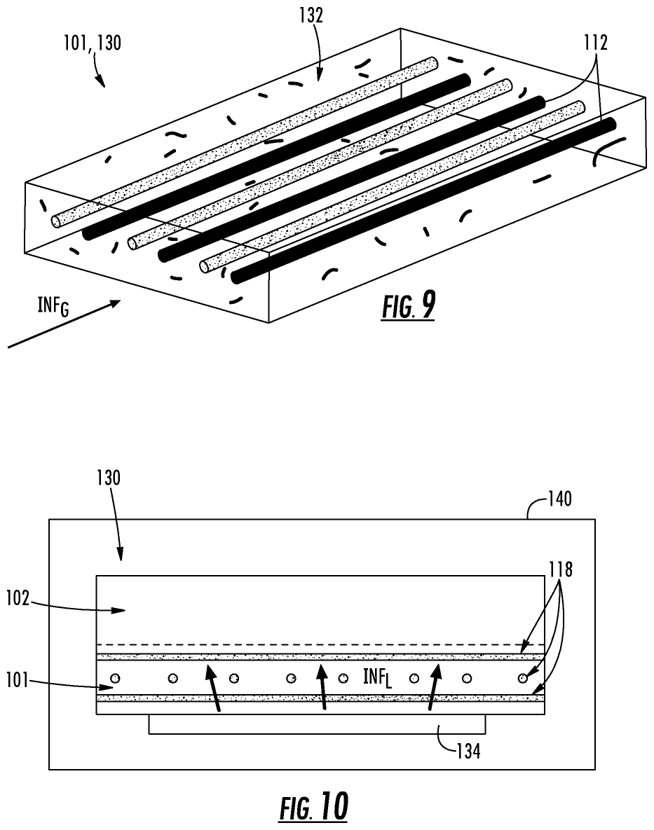

FIG. 9 provides a cross-sectional view of a portion of the first section 101 of the CMC preform 130 undergoing the CVI process according to an embodiment of the present disclosure. As shown, a gaseous infiltrant, INF_{G}, is shown infiltrating the first section 101. The infiltrant INF_{G} infiltrates into the first section 101 to form an infiltrated matrix 132. More particularly, the infiltrant INF_{G} flows over, around, and through the first section 101 (and over and around the second section 102). Notably, the infiltrant INF_{G} flows into the elongated channels 118 and uses them as gas transport paths to better infiltrate into the porous CMC preform 130. In this way, the pores 117 (FIG. 7) of the CMC preform 130 may be infiltrated to increase the density of the final CMC product. CVI-infiltrated composite articles typically have no free silicon, good creep resistance, and the potential to operate at temperatures above 1400° C. (≈2,570° F.). However, as further shown in FIG. 9, the infiltrated elongated channels 118 of the first section 101 of the CMC preform 130 are not entirely filled, and thus, residual porosity within the interior of the article may result. In accordance with aspects of the present disclosure, the partially-infiltrated elongated channels 118 may be treated, e.g., with a polymer solution, and then the CMC preform 130 can be subjected to a melt infiltration process as described below.

At (212), with reference to FIG. 2, in some implementations the method (200) includes machining the densified preform. The densified preform is often more mechanically robust and more resistant to environmental attack than at earlier steps in the process. Machining the densified CMC preform 130 after CVI at (210) can create additional paths for liquid infiltration.

One or more additional layers can be added to the composite structure following the CVI, e.g., after (210) of FIG. 1. In some implementations, the method (200) can further include an additional high temperature annealing step to sinter the oxide coating. This layer can comprise one or more rare-earth oxides, such as e.g., ytterbium oxides, aluminum oxides, aluminum-silica oxides, or alkali-earth oxides, such as barium or strontium oxides. The different oxide materials can be combined in a single layer or more preferably in multiple layers of different compositions and morphologies. The oxide layers can be present prior to melt infiltration, e.g., before (214) of FIG. 1. Following melt infiltration, excess silicon can be removed from the outer surfaces, e.g., at (216) of FIG. 1.

At (214), in some implementations, the method (200) includes applying a polymer solution to the CVI-densified CMC preform 130. That is, the method (200) can include treating the CVI-densified CMC preform with a polymer containing solution to wet the channels. As one example, the polymer solution can comprise a phenolic resin dissolved in an organic carrier solvent, such as e.g., acetone. The polymer solution can be applied in any suitable fashion. For instance, in some embodiments, the CVI-densified CMC preform 130 can be soaked in a polymer solution bath. In other embodiments, the CVI-densified CMC preform 130 can be sprayed with the polymer solution. Preferably, the polymer solution is applied such that it soaks the interior surfaces of the partially-infiltrated elongated channels 118. In this way, the polymer solution deposited on the surfaces of the channel will decompose as carbon to provide better wetting for a subsequent melt infiltration process (described below). Better wetting facilitates the capillary action of the melted-liquid infiltrant (e.g., silicon) into the partially-infiltrated elongated channels 118, and thus, better backfill infiltration is achieved and in a more efficient manner.

At (216), the method (200) includes subjecting the CVI-densified CMC preform to melt infiltration (MI) to backfill the plurality of elongated channels, e.g., to further densify the CMC preform. As noted above, during the CVI process, the elongated channels may be only partially filled and residual porosity may still be present in and along the elongated channels. Accordingly, the CVI-densified CMC preform is melt infiltrated to backfill the elongated channels with a liquid infiltrant to further densify the article. Examples of suitable infiltrants for melt infiltration include molten material, such as silicon, silicon alloys, silicides, oxides, or combinations thereof. An example CVI-densified CMC preform undergoing a melt infiltration process is provided below.

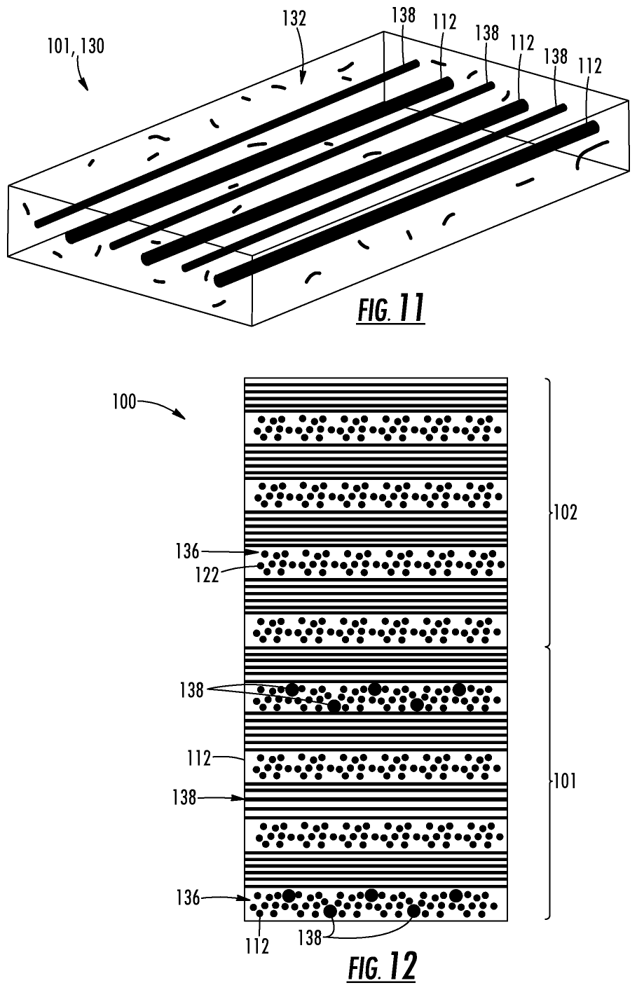

FIG. 10 provides a schematic view of the CVI-densified CMC preform 130 undergoing a melt infiltration process in a thermal system 140 according to an embodiment of the present disclosure. As shown, a block of infiltrant 134, which is silicon in this embodiment, is melted at high temperatures such that it infiltrates the CVI-densified CMC preform 130 in liquid form as represented by INF_{L}. Capillary forces drive the liquid infiltrant INF_{L} into the partially-infiltrated elongated channels 118 of the first section 101 of the CVI-densified CMC preform 130. At least some of the liquid infiltrant INF_{L} can react with carbon to further form the ceramic matrix, e.g., silicon carbide. As such, in some implementations, in subjecting the CVI-densified CMC preform to melt infiltration (MI) at (216), the method (200) includes reacting at least some of the liquid infiltrant with carbon to further form the ceramic matrix (e.g., silicon carbide). Furthermore, as will be described below, some of the of the liquid infiltrant INF_{L} can remain unreacted or “free” within the CMC preform 130.

FIG. 11 provides a cross-sectional view of a portion of the first section 101 of the melt-infiltrated CMC preform 130 according to an embodiment of the present disclosure. As shown, the melt-infiltrated CMC preform 130 includes a ceramic matrix material 136 (“a ceramic matrix”), reinforcing fibers 112, and one or more infiltrant veins 138. The infiltrant veins 138 can be filled with unreacted infiltrant, such as silicon, remaining in the elongated channels 118 after MI. In some embodiments, the infiltrant veins 138 may comprise a core (formed by MI at (216)) and shell (formed by CVI at (212)) structure where the shell is reacted infiltrant and the core is filled of reacted infiltrant. For instance, the infiltrant veins 138 may comprise a shell of silicon carbide and a residual elongated core of unreacted free silicon.

In some embodiments, as shown in FIG. 11, the infiltrant veins 138 are disposed in a generally parallel pattern along the length/width of the CMC article 100. The infiltrant veins 138 are more regular and uniform than prior processes not using sacrificial fibers. In some embodiments, the CMC product comprises a plurality of infiltrant veins 138, wherein the plurality of infiltrant veins 138 are elongated veins disposed in a grid pattern. Infiltrant veins 138 may be formed where some or all of the sacrificial fibers were disposed. In some cases, an elongated channel may be completely reacted to ceramic material while some elongated channels may only partially react to ceramic material leaving infiltrant veins 138 along the CMC article 100. The size, distribution, and location of the sacrificial fibers 116 may be modified to control the formation and distribution of infiltrant veins 138 in the CMC article 100. For instance, the infiltrant veins 138 may have an aspect ratio of about 10 to about 10,000, such as about 20 to about 5,000. The infiltrant veins 138 may also comprise about 0.1% by volume to about 20% by volume, such as about 1% by volume to about 15% by volume, about 1% by volume to about 10% by volume, or about 1% by volume to about 7% by volume of the first section 101 of the CMC article 100. In some embodiments, the infiltrant is molten silicon and the infiltrant veins 138 appear as free silicon content. The free silicon content may be from about 0.1% by volume to about 10% by volume of the first section 101 of the CMC article 100, such as about 1% by volume to about 7% by volume.

Generally, the further densification of the CVI-infiltrated CMC preform using melt infiltration may result in a ceramic matrix composite article that is fully dense, e.g., having generally zero, or less than about 7 or less than about 3 percent by volume residual porosity. This very low porosity gives the composite desirable mechanical properties, such as a high proportional limit strength and interlaminar tensile and shear strengths, high thermal conductivity and good oxidation resistance. The matrices may have a free silicon phase (i.e. elemental silicon or silicon alloy) that may limit the use temperature of the ceramic matrix composite articles to below that of the melting point of the silicon or silicon alloy, or about 1400° C. (≈2,550° F.) to 1410° C. (≈2,570° F.). The free silicon phase may result in a lower creep resistance compared to densification solely by chemical vapor infiltration.

At (218), with reference again to FIG. 2, the method (200) includes finish machining the densified article to form the CMC article. For instance, the densified composite article can be finish machined as necessary. For example, the article can be grinded or otherwise machined, e.g., to bring the article within tolerance and to shape the article to the desired shape. As another example, one or more cooling features may be machined in the final CMC article, such as e.g., by electrical discharge machining (EDM) or laser cutting. In some embodiments, an external coating may be applied.

FIG. 12 provides an example CMC article 100 formed in accordance with the method (200). As shown, the CMC article defines the first section 101 and the second section 102. The CMC article 100 has a ceramic matrix 136 and a plurality of ceramic reinforcing fibers 112, 122 (e.g., SiC fibers) disposed throughout the ceramic matrix 136. Further, the CMC article 100 has one or more infiltrant veins 138 traversing its first section 101. Notably, the one or more infiltrant veins 138 do not traverse the second section 102 of the CMC article.

In some embodiments, as noted above, the one or more infiltrant veins 138 comprise an unreacted infiltrant (e.g., silicon). For instance, for SiC—SiC composites, some of the liquid infiltrant backfilled into the CVI-infiltrated CMC preform 130 during melt infiltration at (216) may not react to form a silicon carbide phase; thus, the liquid infiltrant remains in a silicon phase. To prevent the CMC article 100 from being limited in use and application by the melting temperature of the unreacted infiltrant utilized during melt infiltration, the second section 102 has a thickness greater than about 0.25 mm and preferably above 0.75 mm and is the section that faces or is exposed to temperatures above the melting temperature of the infiltrant. Particularly, the second section 102, which is silicon free, is preferably the section of the CMC article 100 that is exposed to high temperatures (i.e., temperatures above the melting point of the unreacted infiltrant) and the first section 101, which may be silicon rich, is preferably not exposed to the high temperatures that would cause the silicon within the infiltrated veins 138 to melt. The second section 102 creates a thermal gradient between the high temperature environment and the silicon rich first section 101 of the CMC article. Preferably, the second section 102 of the CMC article 100 has a thickness that creates a thermal gradient such that the first section 101 of the CMC article 100 is not exposed to temperatures above about 1400° C. (≈2,570° F.), e.g., above about the melting temperature of silicon.

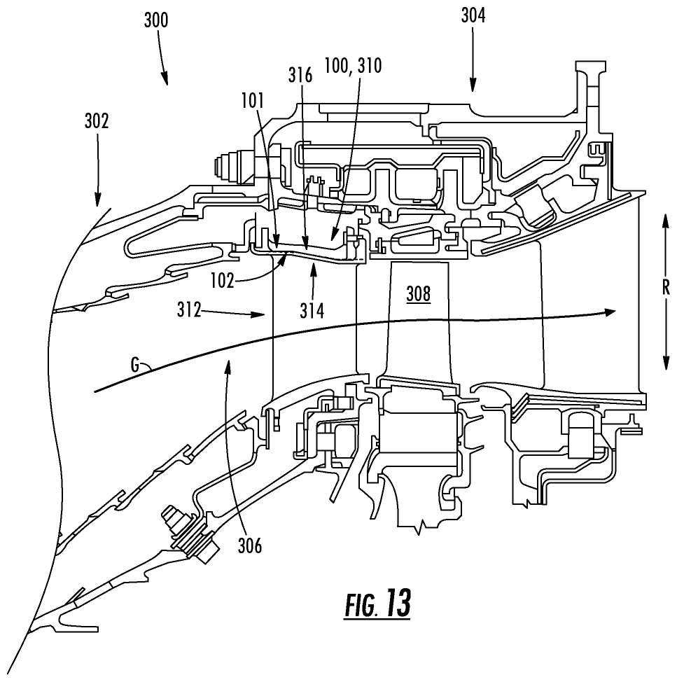

FIG. 13 provides a schematic view of a portion of a gas turbine engine 300 for use with an aircraft according to an embodiment of the present disclosure. More particularly, FIG. 13 provides a close up view of a downstream end of a combustion section 302 as well as a turbine section 304 of the gas turbine engine 300. As shown, the gas turbine engine 300 defines a hot gas path 306 that receives hot combustion gases G that are combusted in the combustion section 302. The combustion gases G flow downstream through the turbine section 304 where energy is extracted from the combustion gases G and used to do work, e.g., to rotate turbine blades 308 (only one shown in FIG. 13), which in turn cause one or more shafts (not shown) to rotate.

As depicted in FIG. 13, the CMC article 100 is positioned or placed along and defines at least a portion of the hot gas path 306 of the gas turbine engine 300. For this embodiment, the CMC article 100 is an outer band 310 of a nozzle segment 312. The first section 101 and the second section 102 of the CMC article 100 are arranged in a stacked arrangement along a radial direction R. Notably, the second section 102 defines a hot side 314 (i.e., a radially inner side) of the CMC article 100 (e.g., the side facing the hot gas path 306) and the first section 101 defines a cold side 316 (i.e., a radially outer side) of the CMC article 100 (e.g., a side facing away from the hot gas path 306). In this way, the silicon rich first section 101 of the CMC article 100 is not exposed to the temperatures above the melting point of silicon. The silicon free second section 102 has a thickness that creates a thermal gradient or temperature drop across the second section 102. For instance, the temperature drop across the second section 102 may be 300° C. or more depending on the thickness of the second section 102 and the temperature of the combustion gases. Accordingly, the unreacted infiltrant (e.g., silicon) within the infiltrant veins traversing the first section 101 are not exposed to temperatures above the melting portion of the unreacted infiltrant. Although the CMC article 100 is shown as an outer band for a nozzle segment in FIG. 13, it will be appreciated that the CMC article 100 may be other suitable flowpath components, such as e.g., as combustion liners, shrouds, nozzle vanes, nozzle inner bands, blades, etc. Further, the CMC article 100 may be employed in engines and other turbomachinery other than aviation engines. For instance, the CMC article 100 may be employed in a turbojet, turboprop and turboshaft gas turbine engines, including industrial and marine gas turbine engines and auxiliary power units. CMC articles can also be used in other applications, such as leading edges and acreage in a hypersonic vehicle.

### EXAMPLES

### Example 1

A specimen of vapor infiltrated SIC—SiC fiber composite was first prepared using the methods and procedures described in U.S. Pat. No. 9,850,174 owned by General Electric Company. U.S. Pat. No. 9,850,174 is hereby incorporated by reference in its entirety. A SiC fiber material (Hi-Nicalon-S) was coated with a slurry material containing a mixture of ceramic solid material, organo-silane SiC precursor polymer, organic pore forming material, and an organic solvent as a liquid carrier for the slurry. The slurry material was chosen so that upon treatment at high temperature in an inert atmosphere a mixture of SiC and C is formed. Due to residual oxide impurities in the initial material, some oxygen can be present in the heat-treated mixture, but this amount is typically less than ten percent (10%) by weight of the heat-treated material. During the formation of the uncured ply, the slurry coated fibers were combined with nylon sacrificial fibers that decompose during the high temperature heat treatment. The spacing of the nylon fibers was about one millimeter (1 mm). The 19 plys of the preform were laid down in an alternating fashion, with each successive ply oriented ninety degrees (90°) to an adjacent ply.

Following assembly of the plys, the resulting preform was treated through two successive heat treatments, including a first relatively low temperature debulking step followed by a second much higher temperature heat treatment (>1000° C.) in a chemically non-reactive environment. During the second heat treatment process, the nylon fibers decomposed, resulting in long straight pores with diameters of between 160-200 microns in each ply. Following the high temperature pyrolysis treatment, the porous preform was vapor infiltrated at high temperature (>1000° C.) using a mixture of hydrogen and methyl trichloro silane (MTS). The MTS thermally decomposed to form solid silicon carbide in the internal portions of the preform, and during the vapor infiltration process, the preform exhibited a weight gain by a factor of about 1.87. Analysis of the deposits created under the conditions used in the vapor infiltration reaction indicated that the deposit is largely SiC (>95%). Optical analysis of the preform indicated that the net residual porosity of the preform was about 21% following the treatment with MTS. The pores created by the decomposition of the nylon fibers were clearly discernable due their large area and generally circular profile.

A portion of the CVI densified preform was sliced using a diamond saw from the larger piece and then melt infiltrated with silicon. A machined edge of the infiltrated preform was placed on a woven carbon felt wick with a pellet composed of >90% silicon. The pellet and the CMC piece were not directly in contact. The amount of silicon was about the same as the weight of the sectioned preform. The SiC CMC, woven carbon wick, and silicon were placed into a boron nitride coated graphite crucible and heated under vacuum, heated to a nominal temperature at least 15° C. above the melting point of pure silicon and held at this temperature for about ½ hour and then allowed to cool under vacuum. Following cooling, the crucible was removed. The silicon melted and migrated through the wick and coated the CMC piece. The coated CMC piece was then cut with a diamond saw. In some of the large pores that were created by the decomposition of the nylon fibers, silicon could be observed. There were, however, large pores that were unfilled toward the center of the sample.

### Example 2

Another machined section of the same vapor-infiltrated CMC preform was selected and pretreated with a 2% solution of organic resin (Novolak FRJ-425), which upon heat treatment at high temperatures under vacuum will decompose but leave a carbon residue in the large pores. This carbon residue is believed to promote infiltration of the liquid silicon into the porous structure. The resin treated CMC piece was then infiltrated with silicon using a similar procedure as described in Example 1 except the heat treatment procedure was modified so the hold time at the highest temperature was about one (1) hour. Following heat treatment, the piece was sectioned and silicon was observed to have infiltrated into the large pores.

While the invention has been described in terms of one or more particular embodiments, it is apparent that other forms could be adopted by one skilled in the art. It is to be understood that the use of “comprising” in conjunction with the coating compositions described herein specifically discloses and includes the embodiments wherein the coating compositions “consist essentially of” the named components (i.e., contain the named components and no other components that significantly adversely affect the basic and novel features disclosed), and embodiments wherein the coating compositions “consist of” the named components (i.e., contain only the named components except for contaminants which are naturally and inevitably present in each of the named components).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for forming a CMC article, the method comprising:
forming a CMC preform defining a first section and a second section, the first section comprising a slurry, reinforcing fibers, and sacrificial fibers and the second section comprising a slurry and reinforcing fibers;
removing the sacrificial fibers to define channels in the first section of the CMC preform;
subjecting the CMC preform to chemical vapor infiltration to densify the CMC preform with an infiltrant; and
subjecting the densified CMC preform to melt infiltration to backfill the channels with a liquid infiltrant.

2. The method of claim 1, wherein the liquid infiltrant comprises silicon or silicon alloy.

3. The method of claim 1, wherein removing the sacrificial fibers comprises:
firing the CMC preform to decompose the sacrificial fibers, wherein the sacrificial fibers are formed of material with a decomposition temperature of about 200° C. to about 650° C.

4. The method of claim 1, wherein the sacrificial fibers comprise a semi-crystalline polymer, a cross-linked polymer, an amorphous polymer, or combinations thereof.

5. The method of claim 1, wherein prior to subjecting the densified CMC preform to melt infiltration to backfill the channels with the infiltrant the method further comprises:
treating the CMC preform with a polymer containing solution to wet the channels.

6. The method of claim 5, wherein the polymer containing solution comprises a phenolic resin.

7. The method of claim 1, wherein forming the CMC preform defining the first section and the second section comprises:
laying up a plurality of second plies to form the second section of the CMC preform, the plurality of second plies forming the second section comprising the slurry and the reinforcing fibers; and
laying up a plurality of second plies and one or more first plies to form the first section of the CMC preform, the one or more first plies comprising the slurry, the reinforcing fibers, and the sacrificial fibers;
combining the second section with the first section to form the CMC preform.

8. The method of claim 7, wherein the one or more first plies of the first section are laid up such that each first ply of the one or more first plies is spaced from other first plies by at least one second ply of the plurality of second plies.

9. The method of claim 7, wherein forming the first section of the CMC preform comprises:
forming the sacrificial fibers in a parallel direction to the reinforcement fibers within a ply of the one or more first plies.

10. The method of claim 7, wherein the plurality of second plies of the second section of the CMC preform are laid up to define a thickness of the second section between about 0.75 mm and 3 mm.

11. The method of claim 7, wherein the first section and the second section are combined prior to subjecting the CMC preform to chemical vapor infiltration and prior to subjecting the densified CMC preform to melt infiltration.

12. The method of claim 1, wherein the sacrificial fibers have an aspect ratio of about 10 to about 10,000.

13. The method of claim 1, wherein the sacrificial fibers are continuous along a length or width of the CMC preform.

14. The method of claim 1, wherein sacrificial fibers have an average diameter of about 10 μm to about 200 μm.

15. The method of claim 1, further comprising:
placing the CMC article along a hot gas path defined by a gas turbine engine, and wherein the second section defines a hot side of the CMC article and the first section defines a cold side of the CMC article.

16. A CMC article defining a first section and a second section, the CMC article comprising:
a ceramic matrix;
a plurality of ceramic reinforcing fibers disposed throughout the ceramic matrix; and
one or more infiltrant veins traversing the first section of the CMC article, and
wherein the second section has a thickness greater than about 0.75 mm.

17. The CMC article of claim 16, wherein the one or more infiltrant veins do not traverse the second section of the CMC article.

18. The CMC article of claim 16, wherein the one or more infiltrant veins comprise an unreacted infiltrant, and wherein the second section is exposed to temperatures above a melting temperature of the unreacted infiltrant.

19. The CMC article of claim 16, wherein the CMC article is positioned along and defines at least a portion of a hot gas path of a gas turbine engine, and wherein the second section defines a hot side of the CMC article and the first section defines a cold side of the CMC article.

20. A method for forming a CMC article, the method comprising:
laying up a preform having a first section and a second section, the first section having a plurality of plies comprising a slurry and reinforcing fibers and the second section having a plurality of plies comprising a slurry and reinforcing fibers, and wherein one or more of the plurality of plies of the first section comprise sacrificial fibers;
consolidating the preform at elevated temperatures and pressures to form a pre-green state article;
firing the pre-green state article to form a green state article, wherein during firing, the sacrificial fibers are burned out such that a plurality of elongated channels are defined by the first section of the green state article;
subjecting the green state article to chemical vapor infiltration to densify the green state article with an infiltrant to form a CVI-densified article; and
subjecting the CVI-densified article to melt infiltration to backfill the plurality of elongated channels with an infiltrant.
